(19) United States
(12) Patent Application Publication
(10) Pub. No.: US 2026/0302890 A1
(43) Pub. Date: Oct. 1, 2026

(54) COOLING STRUCTURE OF ROTATING ELECTRIC MACHINE

(71) Applicant: HONDA MOTOR CO., LTD., Tokyo (JP)

(72) Inventors: Eiji Shirado, Wako-shi (JP); Kojiro Ohsaki, Wako-shi (JP); Naoki Kamimura, Wako-shi (JP)

(21) Appl. No.: 19/629,195

(22) Filed: Mar. 26, 2026

(30) Foreign Application Priority Data
Mar. 27, 2025 (JP) 2025-053876

(51) Int. Cl. H02K 9/19; B64C 29/00; B64D 33/08; H02K 1/20; H02K 3/24; H02K 21/22

(52) U.S. Cl. CPC H02K 9/19; B64C 29/00; B64D 33/08; H02K 1/20; H02K 3/24; H02K 21/22

(57) ABSTRACT

A cooling structure of a rotating electric machine includes: a first common flow path member having electrical conductivity; a second common flow path member having electrical conductivity; and a plurality of connecting flow path members which connect the first common flow path member and the second common flow path member, which are inserted into a stator provided in the rotating electric machine, and each of which at least partially has electrical conductivity. Each of the plurality of connecting flow path members includes an insulating portion.

### CROSS-REFERENCE TO RELATED APPLICATIONS

This application is based upon and claims the benefit of priority from Japanese Patent Application No. 2025-053876 filed on Mar. 27, 2025, the contents of which are incorporated herein by reference.

### BACKGROUND OF THE INVENTION

### Field of the Invention

The present disclosure relates to a cooling structure of a rotating electric machine.

### Description of the Related Art

JP 4442207 B2 discloses a U-shaped cooling pipe for cooling a rotating electric machine. In order to reduce a circulating (electric) current, an insulation structure is provided at the end portion of the U-shaped cooling pipe.

### SUMMARY OF THE INVENTION

It is desirable to reduce generation of a circulating current with a simple configuration in a cooling structure of a rotating electric machine.

The present disclosure has the object of solving the above-described problem.

An aspect of the present disclosure is characterized by a cooling structure of a rotating electric machine, the cooling structure comprising: a first common flow path member which has electrical conductivity and through which a coolant flows; a second common flow path member which has electrical conductivity and through which the coolant flows; and a plurality of connecting flow path members configured to connect the first common flow path member and the second common flow path member, wherein each of the plurality of connecting flow path members includes: a first pipe having electrical conductivity, inserted into a stator, and connected to the first common flow path member; a second pipe having electrical conductivity, inserted into the stator, and connected to the second common flow path member; and a connecting pipe configured to connect the first pipe and the second pipe, the connecting pipe including an insulating portion configured to prevent flow of electric current between the first pipe and the second pipe.

According to the cooling structure of the rotating electric machine of the present disclosure, since the connecting flow path member includes the insulating portion, the generation of the circulating current can be reduced with a simple configuration. As a result, the loss of the rotating electric machine can be reduced.

The above and other objects, features, and advantages of the present invention will become more apparent from the following description when taken in conjunction with the accompanying drawings, in which a preferred embodiment of the present invention is shown by way of illustrative example.

### BRIEF DESCRIPTION OF THE DRAWINGS

FIG. 1 is an external perspective view of a flying object;

FIG. 2 is a transverse cross-sectional view of a motor;

FIG. 3 is a perspective view of a stator and a cooling structure;

FIG. 4 is a cross-sectional view of the stator and the cooling structure;

FIG. 5A is a first explanatory diagram of a circulating current;

FIG. 5B is a second explanatory diagram of the circulating current;

FIG. 6 is a cross-sectional view illustrating a first modification of the stator and the cooling structure; and

FIG. 7 is a cross-sectional view illustrating a second modification of the stator and the cooling structure.

### DETAILED DESCRIPTION OF THE INVENTION

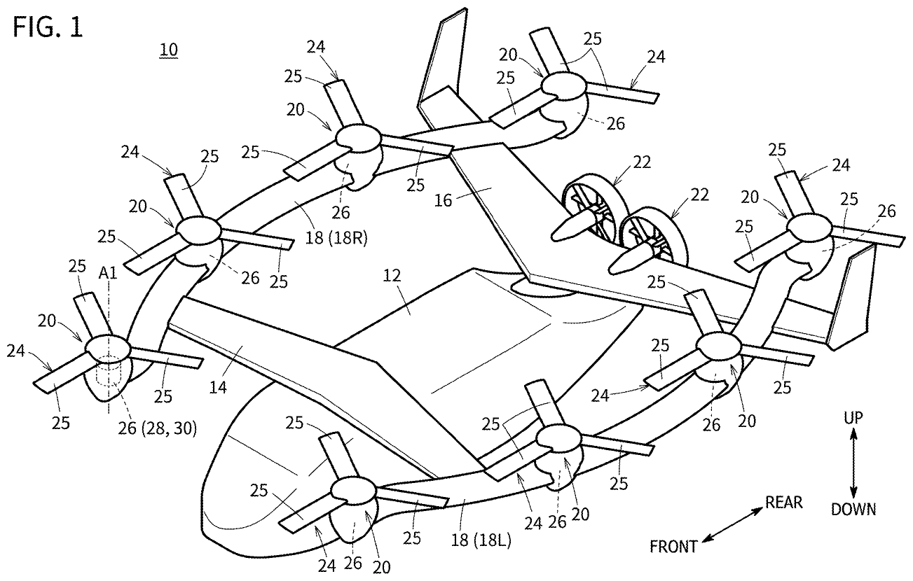

A flying object 10 shown in FIG. 1 is a vertical take-off and landing aircraft (VTOL aircraft). Although the flying object 10 shown in FIG. 1 is a passenger aircraft, the flying object 10 may be an unmanned aerial vehicle such as a drone. In the present disclosure, a direction in which the flying object 10 flies when cruising is defined as “forward”, and a direction opposite to “forward” is defined as “rearward”.

The flying object 10 is, for example, an electric vertical take-off and landing aircraft (so-called eVTOL aircraft). The flying object 10 includes a fuselage 12, a front wing 14, a rear wing 16, two booms 18, eight VTOL rotors 20, and two cruise rotors 22.

The front wing 14 is connected to a front portion of the fuselage 12. The rear wing 16 is connected to a rear portion of the fuselage 12. The front wing 14 and the rear wing 16 generate lift as the flying object 10 moves forward.

The two booms 18 extend in the front-rear direction. One of the two booms 18 is a right boom 18R disposed on the right side of the fuselage 12. The other of the two booms 18 is a left boom 18L disposed on the left side of the fuselage 12.

Four VTOL rotors 20 are arranged on the right boom 18R sequentially toward the rear. Similarly, four VTOL rotors 20 are arranged on the left boom 18L sequentially toward the rear. Each VTOL rotor 20 is a propeller device that generates thrust (lift) in a vertically upward direction. Each VTOL rotor 20 is used in a takeoff phase, a vertical climb phase, a transition phase from the climb phase to cruise, a transition phase from the cruise to a descent phase, a vertical descent phase, a landing phase, and a hovering phase.

Each VTOL rotor 20 includes a propeller 24 and a motor 26. Hereinafter, the rotational central axis of the propeller 24 is referred to as a “rotational axis A1”. Regarding the VTOL rotor 20 and its components, a direction lying along the rotational axis A1 is referred to as an “axial direction.” A direction around the rotational axis A1 is referred to as a “circumferential direction”, and a direction perpendicular to the rotational axis A1 is referred to as a “radial direction (radially)”.

The propeller 24 includes a plurality of blades 25 arranged at equal intervals in the circumferential direction. In the present embodiment, the number of the blades 25 included in each propeller 24 is three, but in another aspect, the number of the blades 25 included in each propeller 24 may be two, or four or more.

The motor 26 is a rotational driving source for rotating the propeller 24. The motor 26 is operated by electric power. The motor 26 is a multiphase AC motor (for example, a three-phase AC motor). The motor 26 includes a rotor 28 and a stator 30. The rotor 28 is a portion of the motor 26 that rotates about the rotational axis A1 relative to the airframe (the boom 18) of the flying object 10. That is, the rotor 28 is a rotating body that rotates the propeller 24. The stator 30 will be described in detail later.

Two cruise rotors 22 are arranged on the rear wing 16 so as to be arranged side by side in the left-right direction. Each cruise rotor 22 is used in a cruise phase, a transition phase from the climb phase to the cruise, and a transition phase from the cruise to the descent phase. Each cruise rotor 22 is a thrust generating device that causes air to flow from the front to the rear, and generates thrust for causing the flying object 10 to fly in a substantially horizontal direction.

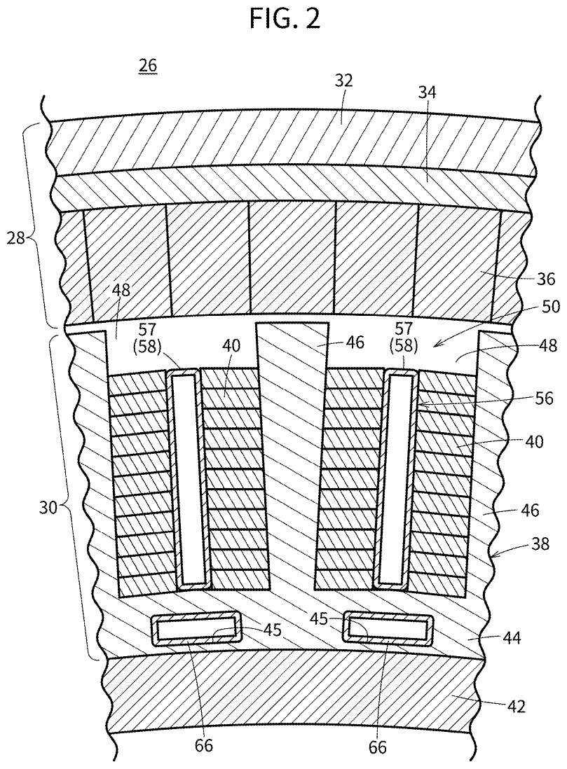

As shown in FIG. 2, in the present embodiment, the motor 26 is a so-called outer rotor motor having a configuration in which the rotor 28 is disposed outside the stator 30. The motor 26 may be a so-called inner rotor motor in which the rotor 28 is disposed on the inner side of the stator 30.

The rotor 28 is disposed so as to surround the stator 30. The rotor 28 includes a rotor case 32, a rotor core 34, and a plurality of magnets 36. The rotor core 34 having a substantially cylindrical shape is attached to the inner periphery of the rotor case 32. The plurality of magnets 36 are attached to the inner periphery of the rotor core 34. The plurality of magnets 36 are arranged so as to surround the outer periphery of the stator 30.

The stator 30 includes a stator core 38 and a plurality of electromagnetic coils 40. The stator 30 is held by a stator holding member 42 disposed on the inner side of the stator 30. The stator core 38 includes a circular annular portion 44, a plurality of teeth 46, and a plurality of slots 48. The circular annular portion 44 is a back yoke. The plurality of teeth 46 are provided at intervals in the circumferential direction. The plurality of teeth 46 protrude radially outward from the circular annular portion 44. The plurality of slots 48 are formed between the plurality of teeth 46. Accordingly, the plurality of slots 48 are provided at intervals in the circumferential direction. Note that, in the case where the motor 26 is an inner rotor motor, the plurality of teeth 46 protrude radially inward from the circular annular portion 44.

The plurality of electromagnetic coils 40 are wound around the plurality of teeth 46, respectively. Therefore, a part of one of the electromagnetic coils 40 adjacent to each other and a part of the other of the electromagnetic coils 40 adjacent to each other are inserted into each slot 48.

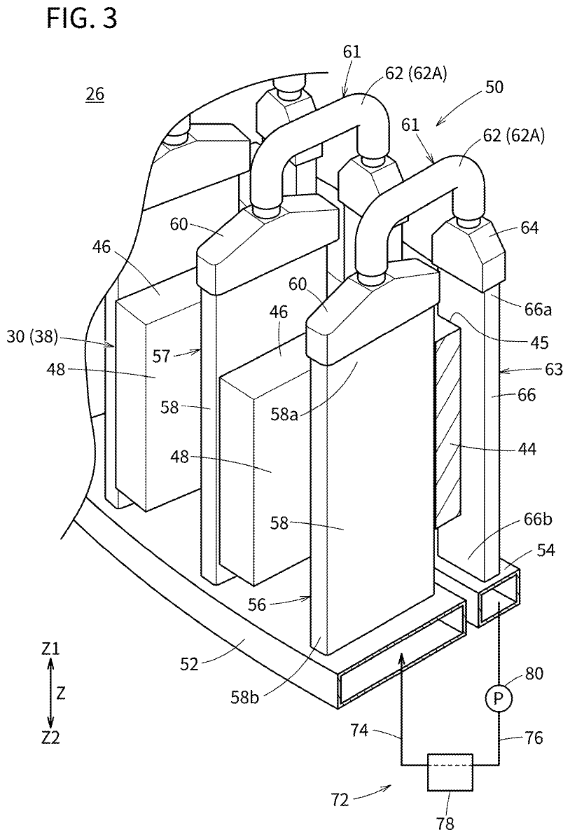

The motor 26 further includes a cooling structure 50. The cooling structure 50 is a structure for cooling the stator 30 with a coolant. The coolant is, for example, a cooling liquid. As shown in FIG. 3, the cooling structure 50 includes a first common flow path member 52, a second common flow path member 54, and a plurality of connecting flow path members 56. In FIG. 3, the electromagnetic coils 40 (FIG. 2) are not shown.

The first common flow path member 52 is a hollow member including therein a flow path through which the coolant flows. The first common flow path member 52 is made of a material having electrical conductivity (for example, a metal material). The first common flow path member 52 is formed in a circular annular shape extending along the circumferential direction of the stator 30. The first common flow path member 52 is disposed on one side (a Z2 direction side) of the stator 30 in the axial direction of the motor 26. In the present embodiment, the first common flow path member 52 is located closer to the center of gravity of the flying object 10 (FIG. 1) mounted with the motor 26 than the stator 30 is.

The second common flow path member 54 is a hollow member including therein a flow path through which the coolant flows. The second common flow path member 54 is made of a material having electrical conductivity (for example, a metal material). The second common flow path member 54 is formed in a circular annular shape extending along the circumferential direction of the stator 30. The second common flow path member 54 is disposed on one side (the Z2 direction side) of the stator 30 in the axial direction of the motor 26. In the present embodiment, the second common flow path member 54 is located closer to the center of gravity of the flying object 10 (FIG. 1) mounted with the motor 26 than the stator 30 is.

The second common flow path member 54 is disposed radially inward of the first common flow path member 52. Accordingly, the first common flow path member 52 surrounds the second common flow path member 54 on the radially outer side of the second common flow path member 54. It should be noted that, in the case where the motor 26 is configured as an inner rotor motor, the second common flow path member 54 is disposed so as to surround the first common flow path member 52 on the radially outer side of the first common flow path member 52.

The plurality of connecting flow path members 56 connect the first common flow path member 52 and the second common flow path member 54. The plurality of connecting flow path members 56 are disposed at intervals in the circumferential direction. Each of the connecting flow path members 56 has one end connected to the first common flow path member 52 and the other end connected to the second common flow path member 54. Each of the connecting flow path members 56 is formed in a substantially U-shape when viewed in the circumferential direction.

Each of the connecting flow path members 56 is a pipe member at least a part of which has electrical conductivity. The connecting flow path members 56 are inserted into the stator 30. In the present embodiment, each of the connecting flow path members 56 includes a first pipe 57, a second pipe 63, and a connecting pipe 61. The first pipe 57 includes a slot pipe 58 and a first cap 60. The second pipe 63 includes a second cap 64 and a back yoke pipe 66.

As shown in FIG. 2, the slot pipe 58 is disposed (inserted) between the electromagnetic coils 40 adjacent to each other in the circumferential direction. The slot pipe 58 is made of a material having electrical conductivity (for example, a metal material). The slot pipe 58 includes therein a flow path through which the coolant flows. The flow path of the slot pipe 58 communicates with the flow path of the first common flow path member 52 (FIG. 3).

The slot pipe 58 has a larger dimension in the radial direction of the stator 30 than in the circumferential direction of the stator 30. Therefore, the slot pipe 58 has a flat shape having a thickness in the circumferential direction of the stator 30. In the present embodiment, the cross-sectional shape of the slot pipe 58 in a plane perpendicular to the axial direction of the stator 30 is substantially rectangular. The slot pipe 58 abuts on the electromagnetic coils 40 adjacent to the slot pipe 58 on both sides thereof in the circumferential direction. The cross-sectional shape of the slot pipe 58 is formed in a shape corresponding to a region (inter-coil region) between the electromagnetic coils 40 adjacent to each other. The first pipe 57 (the slot pipe 58) is not in direct contact with the stator core 38.

As shown in FIG. 3, the slot pipe 58 extends along the axial direction of the stator 30 (a Z direction). The slot pipe 58 has a first end portion 58a which is one end portion (an upper end portion) in the longitudinal direction, and a second end portion 58b which is the other end portion (a lower end portion) in the longitudinal direction.

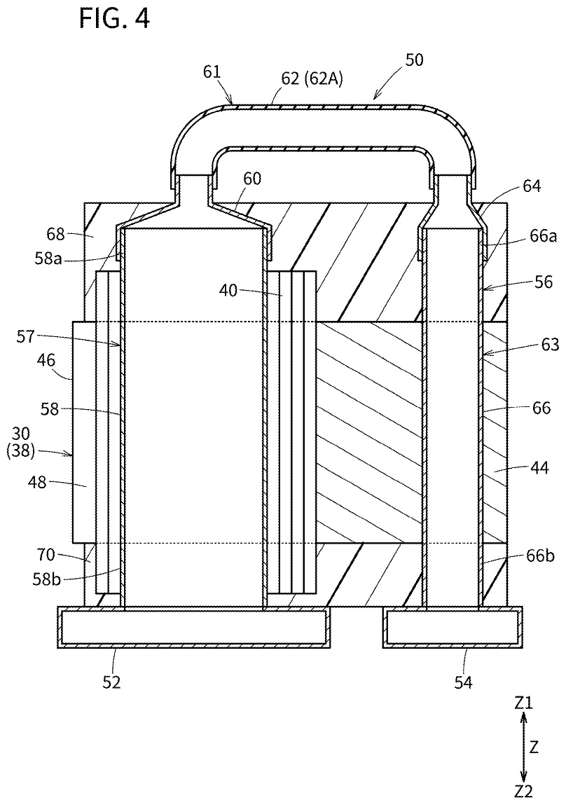

As shown in FIG. 4, the first end portion 58a protrudes beyond one end surface (an upper end surface) of the stator core 38. The second end portion 58b protrudes beyond the other end surface (a lower end surface) of the stator core 38. The second end portion 58b is joined to the first common flow path member 52 by welding, for example.

The first cap 60 is joined to the first end portion 58a of the slot pipe 58. The first cap 60 is connected to the first end portion 58a of the slot pipe 58 so as to cover the opening of the first end portion 58a. The first cap 60 is disposed outside the slot 48 (above the slot 48 in the present embodiment). The first cap 60 is made of an electrically conductive material, for example, metal. In the case where the first cap 60 is made of metal, the first cap 60 is joined to the slot pipe 58 by welding, for example.

The connecting pipe 61 connects the first pipe 57 and the second pipe 63. The connecting pipe 61 includes an insulating portion 62 for preventing the flow of electric current between the first pipe 57 and the second pipe 63. The insulating portion 62 is a tube having one end connected to the first cap 60 and the other end connected to the second cap 64. At least a part of the insulating portion 62 extends along the radial direction of the stator 30. The insulating portion 62 is disposed outside the slot 48 (above the stator core 38 in the present embodiment).

The insulating portion 62 is made of, for example, a rubber material, a resin material, or an insulating ceramic. Examples of the insulating ceramic include alumina ceramic. The insulating portion 62 may be an insulating pipe member 62A having stretchability. In the case where the insulating portion 62 is made of a rubber material, the insulating portion 62 is the insulating pipe member 62A having stretchability. In the case where the insulating portion 62 is made of a resin material or an insulating ceramic formed in a bellows shape, the insulating portion 62 is the insulating pipe member 62A having stretchability.

The second cap 64 is joined to the upper end portion of the back yoke pipe 66. The second cap 64 is connected to the back yoke pipe 66 so as to cover the upper end opening of the back yoke pipe 66. The second cap 64 is disposed outside the slot 48 (above the slot 48 in the present embodiment). The second cap 64 is made of an electrically conductive material, for example, metal. In the case where the second cap 64 is made of metal, the second cap 64 is joined to the back yoke pipe 66 by welding, for example.

As shown in FIG. 2, the slot pipe 58 and the back yoke pipe 66 are lined up in the radial direction of the stator 30. The dimension of the back yoke pipe 66 in the circumferential direction of the stator 30 is larger than the dimension of the back yoke pipe 66 in the radial direction of the stator 30. Therefore, the back yoke pipe 66 has a flat shape having a thickness in the radial direction of the stator 30.

As shown in FIG. 3, the back yoke pipe 66 is inserted into a pipe insertion hole 45 formed in the circular annular portion 44 of the stator core 38. The pipe insertion hole 45 penetrates the circular annular portion 44 in the axial direction. The back yoke pipe 66 is made of a material having electrical conductivity (for example, a metal material). The back yoke pipe 66 abuts on the circular annular portion 44 in the pipe insertion hole 45. The back yoke pipe 66 includes therein a flow path through which the coolant flows. The flow path of the back yoke pipe 66 communicates with the flow path of the second common flow path member 54. The second pipe 63 (the back yoke pipe 66) is in direct contact with the stator core 38.

The back yoke pipe 66 extends along the axial direction of the stator 30. The back yoke pipe 66 has a first end portion 66a which is one end portion (an upper end portion) in the longitudinal direction, and a second end portion 66b which is the other end portion (a lower end portion) in the longitudinal direction. As shown in FIG. 4, the first end portion 66a protrudes beyond one end surface (the upper end surface) of the stator core 38. The second end portion 66b of the back yoke pipe 66 protrudes beyond the other end surface (the lower end surface) of the stator core 38. The second end portion 66b is joined to the second common flow path member 54 by welding, for example.

Portions of the electromagnetic coil 40, the first end portion 58a of the slot pipe 58, and the first end portion 66a of the back yoke pipe 66, which protrude in a Z1 direction beyond the stator core 38, are covered with a potting resin 68. The first cap 60 (excluding the upper end portion thereof) and the second cap 64 (excluding the upper end portion thereof) are also covered with the potting resin 68. On the other hand, the insulating portion 62 is not covered with the potting resin 68.

Portions of the electromagnetic coil 40, the second end portion 58b of the slot pipe 58, and the second end portion 66b of the back yoke pipe 66, which protrude in the Z2 direction beyond the stator core 38, are covered with a potting resin 70. A part (upper part) of the first common flow path member 52 and a part (upper part) of the second common flow path member 54 are also covered with the potting resin 70.

As shown in FIG. 3, the cooling structure 50 further includes a coolant circulation circuit 72. The coolant circulation circuit 72 includes a supply line 74, a discharge line 76, and a heat exchanger 78. The supply line 74 is connected to the first common flow path member 52. The supply line 74 is configured to supply the coolant to the first common flow path member 52. The discharge line 76 is connected to the second common flow path member 54. The discharge line 76 is configured to discharge the coolant from the second common flow path member 54. The discharge line 76 is provided with a pump 80. The heat exchanger 78 is connected to the supply line 74 and the discharge line 76. The heat exchanger 78 cools the coolant discharged from the second common flow path member 54 via the discharge line 76.

The cooling structure 50 cools the motor 26 (the stator 30) as follows.

The coolant is supplied to the first common flow path member 52 via the supply line 74. The coolant flows through the first common flow path member 52 in the circumferential direction and flows into the plurality of connecting flow path members 56. Specifically, the coolant flows through the slot pipes 58 in the axial direction (the Z1 direction). The coolant flows from the slot pipes 58 into the insulating portions 62 via the first caps 60, and flows into the back yoke pipes 66 via the second caps 64. The coolant flows through the back yoke pipes 66 in the axial direction (the Z2 direction) and flows into the second common flow path member 54. As a result, the coolants flowing out of the plurality of connecting flow path members 56 merge in the second common flow path member 54. The coolant flows out of the second common flow path member 54 and returns to the heat exchanger 78 via the discharge line 76. The coolant is cooled by the heat exchanger 78, and then supplied again to the first common flow path member 52 via the supply line 74.

The cooling structure 50 according to the present embodiment has the following effects.

As described above, the cooling structure 50 includes the first common flow path member 52 having electrical conductivity, the second common flow path member 54 having electrical conductivity, and the plurality of connecting flow path members 56 that connect the first common flow path member 52 and the second common flow path member 54. Each of the plurality of connecting flow path members 56 includes the first pipe 57, the second pipe 63, and the connecting pipe 61. The connecting pipe 61 includes the insulating portion 62 for preventing the flow of electric current between the first pipe 57 and the second pipe 63. In this manner, since each of the connecting flow path members 56 includes the insulating portion 62, it is possible to reduce the generation of a circulating current with a simple configuration. As a result, the loss of the rotating electric machine (the motor 26) can be reduced.

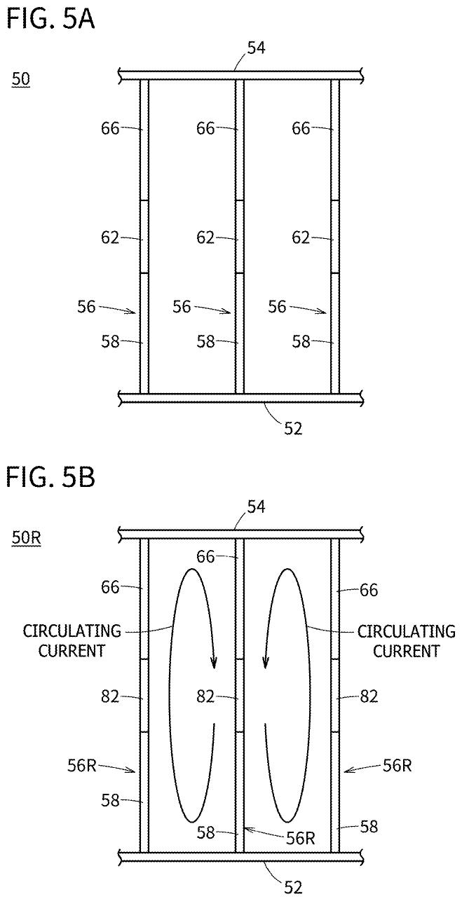

The reduction of the generation of the circulating current will be described with reference to FIGS. 5A and 5B. FIG. 5A conceptually shows the cooling structure 50 according to the present embodiment. FIG. 5B conceptually shows a cooling structure 50R according to a comparative example. As shown in FIG. 5B, unlike the present embodiment, in the cooling structure 50R including a plurality of connecting flow path members 56R in which the slot pipes 58 and the back yoke pipes 66 are connected by electrically conductive connecting portions 82, the first common flow path member 52 and the second common flow path member 54 are electrically connected to each other via the plurality of connecting flow path members 56R. Therefore, in the configuration of FIG. 5B, an electrically conductive circuit is configured by the first common flow path member 52, the second common flow path member 54, and the plurality of connecting flow path members 56R, and a circulating current is generated due to the influence of the magnetic fluxes from the electromagnetic coils 40 (FIG. 2).

In contrast, as shown in FIG. 5A, according to the present embodiment, since each of the plurality of connecting flow path members 56 includes the insulating portion 62, an electrically conductive circuit is not formed. Therefore, the generation of the circulating current can be reduced (prevented).

As shown in FIG. 3, the first common flow path member 52 and the second common flow path member 54 are disposed on one side (the Z2 direction side) of the stator 30 in the axial direction of the motor 26. According to such a configuration, since the first common flow path member 52 and the second common flow path member 54 are disposed on one side of the stator 30, the routing of the piping is improved.

The first common flow path member 52 and the second common flow path member 54 are located closer to the center of gravity of the flying object 10 (FIG. 1) mounted with the rotating electric machine than the stator 30 is. Since the first common flow path member 52 and the second common flow path member 54 are filled with the coolant and are therefore heavy, disposing these common flow path members closer to the center of gravity of the flying object 10 improves the maneuverability.

The insulating portion 62 is disposed outside the slot 48 formed in the stator 30. In general, since the insulating material has low thermal conductivity, the performance of cooling the stator 30 is lowered if the insulating portion 62 is disposed in the slot 48. By disposing the insulating portion 62 outside the slot 48, it is possible to reduce the generation of the circulating current without lowering the cooling performance.

The insulating portion 62 includes, in at least a part thereof, the insulating pipe member 62A having stretchability. By using the insulating pipe member 62A having stretchability, the generation of the circulating current can be reduced. Vibration and thermal stress and strain received from the motor 26 and other components can be absorbed, and component durability is improved.

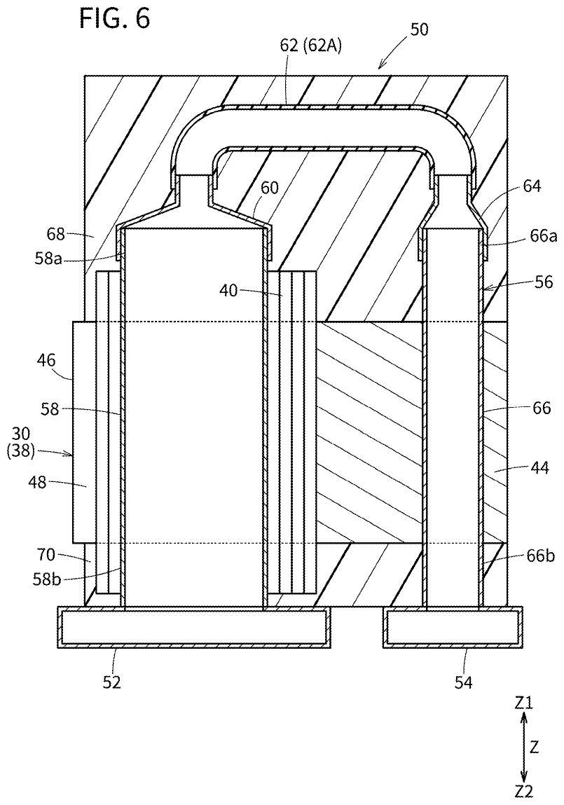

As shown in FIG. 6, the insulating pipe member 62A may be covered with the potting resin 68. According to such a configuration, when the coolant flows through the insulating pipe member 62A, heat of the coolant can be removed via the potting resin 68. In this case, although the insulating pipe member 62A in the configuration of FIG. 6 is less stretchable than in the configuration of FIG. 4, the potting resin 68 itself has a vibration damping property and can absorb vibrations received from the motor 26 and other components, thereby improving component durability. Since the insulating pipe member 62A is covered with the potting resin 68, the connecting parts of the connecting flow path member 56 can be prevented from being detached from each other.

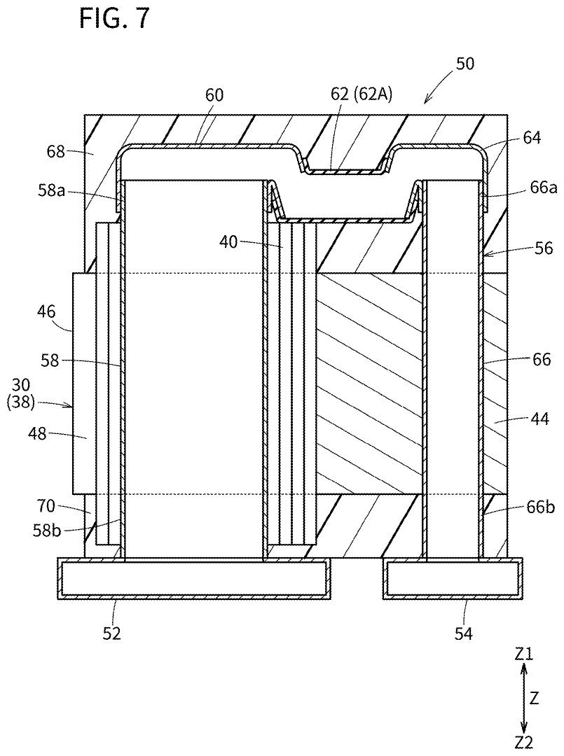

As shown in FIG. 7, the insulating pipe member 62A may be disposed in a shape that conforms to the electromagnetic coil 40. In this case, the insulating pipe member 62A abuts on one end surface of the electromagnetic coil 40. The insulating pipe member 62A is disposed on the Z2 direction side of the first cap 60 and the second cap 64. According to such a configuration, the stator 30 can be cooled more efficiently.

It should be noted that the technique of the present disclosure is not limited to being applicable to the motor 26, and is also applicable to a generator. That is, the technique of the present disclosure is applicable to a rotating electric machine.

The following supplementary notes are further disclosed in relation to the above-described embodiment.

### Supplementary Note 1

The cooling structure (50) of the rotating electric machine according to the present disclosure includes: the first common flow path member (52) which has electrical conductivity and through which coolant flows; the second common flow path member (54) which has electrical conductivity and through which the coolant flows, and the plurality of connecting flow path members (56) configured to connect the first common flow path member and the second common flow path member, wherein each of the plurality of connecting flow path members includes: the first pipe (57) having electrical conductivity, inserted into the stator (30), and connected to the first common flow path member; the second pipe (63) having electrical conductivity, inserted into the stator, and connected to the second common flow path member; and the connecting pipe (61) configured to connect the first pipe and the second pipe, the connecting pipe including the insulating portion (62) configured to prevent flow of electric current between the first pipe and the second pipe. According to such a configuration, since the connecting flow path members each include the insulating portion, it is possible to reduce the generation of a circulating current with a simple configuration. As a result, the loss of the rotating electric machine can be reduced.

### Supplementary Note 2

In the cooling structure of the rotating electric machine according to Supplementary Note 1, the first common flow path member and the second common flow path member may be disposed on one side of the stator in the axial direction of the rotating electric machine. According to such a configuration, since the first common flow path member and the second common flow path member are disposed on one side of the stator, the routing of the piping is improved.

### Supplementary Note 3

In the cooling structure of the rotating electric machine according to Supplementary Note 1, the first common flow path member and the second common flow path member may be located closer to the center of gravity of the flying object (10) mounted with the rotating electric machine than the stator is. Since the first common flow path member and the second common flow path member are filled with the coolant and are therefore heavy, disposing these common flow path members closer to the center of gravity of the flying object improves the maneuverability.

### Supplementary Note 4

In the cooling structure of the rotating electric machine according to Supplementary Note 1, the insulating portion may be disposed outside the slot (48) formed in the stator. In general, since the insulating material has low thermal conductivity, the performance of cooling the stator is lowered if the insulating portion is disposed in the slot. By disposing the insulating portion outside the slot, it is possible to reduce the generation of the circulating current without lowering the cooling performance.

### Supplementary Note 5

In the cooling structure of the rotating electric machine according to any one of Supplementary Notes 1 to 4, the insulating portion may include, in at least a part thereof, the insulating pipe member (62A) having stretchability. By using the insulating pipe member having stretchability, the generation of the circulating current can be reduced. Vibration and thermal stress and strain received from the rotating electric machine and other components can be absorbed, and component durability is improved.

### Supplementary Note 6

In the cooling structure of the rotating electric machine according to Supplementary Note 5, the insulating pipe member may be covered with the potting resin (68). When the coolant flows through the insulating pipe member, heat of the coolant can be removed via the potting resin. Since the potting resin itself has a vibration damping property, it can absorb vibrations received from the rotating electric machine and other components, thereby improving component durability. Since the insulating pipe member is covered with the potting resin, the connecting parts of the connecting flow path member can be prevented from being detached from each other.

### Supplementary Note 7

In the cooling structure of the rotating electric machine according to Supplementary Note 5, the insulating pipe member may be disposed in a shape that conforms to the electromagnetic coil (40) provided in the stator. According to such a configuration, the stator can be cooled more efficiently.

### Supplementary Note 8

In the cooling structure of the rotating electric machine according to any one of Supplementary Notes 1 to 4, the first pipe may not be in direct contact with the stator core (38), and the second pipe may be in direct contact with the stator core.

### Supplementary Note 9

In the cooling structure of the rotating electric machine according to Supplementary Note 8, the first pipe may be inserted into the slot (48) formed in the stator core, and the second pipe may penetrate the back yoke of the stator core.

Although the present disclosure has been described in detail, the present disclosure is not limited to the above-described individual embodiments. Various additions, replacements, modifications, partial deletions, and the like can be made to these embodiments without departing from the essence and gist of the present disclosure, or without departing from the essence and gist of the present disclosure derived from the claims and equivalents thereof. Further, these embodiments can also be implemented in combination. For example, in the above-described embodiments, the order of operations and the order of processes are shown as examples, and are not limited to these. Furthermore, the same applies to a case where numerical values or mathematical expressions are used in the description of the above-described embodiments.

1. A cooling structure of a rotating electric machine, the cooling structure comprising:
a first common flow path member which has electrical conductivity and through which a coolant flows;
a second common flow path member which has electrical conductivity and through which the coolant flows; and
a plurality of connecting flow path members configured to connect the first common flow path member and the second common flow path member,
wherein each of the plurality of connecting flow path members includes: a first pipe having electrical conductivity, inserted into a stator, and connected to the first common flow path member; a second pipe having electrical conductivity, inserted into the stator, and connected to the second common flow path member; and a connecting pipe configured to connect the first pipe and the second pipe, the connecting pipe including an insulating portion configured to prevent flow of electric current between the first pipe and the second pipe.

2. The cooling structure of the rotating electric machine according to claim 1, wherein
the first common flow path member and the second common flow path member are disposed on one side of the stator in an axial direction of the rotating electric machine.

3. The cooling structure of the rotating electric machine according to claim 1, wherein
the first common flow path member and the second common flow path member are located closer to a center of gravity of a flying object mounted with the rotating electric machine than the stator is.

4. The cooling structure of the rotating electric machine according to claim 1, wherein
the insulating portion is disposed outside a slot formed in the stator.

5. The cooling structure of the rotating electric machine according to claim 1, wherein
the insulating portion includes, in at least a part of the insulating portion, an insulating pipe member having stretchability.

6. The cooling structure of the rotating electric machine according to claim 5, wherein
the insulating pipe member is covered with a potting resin.

7. The cooling structure of the rotating electric machine according to claim 5, wherein
the insulating pipe member is disposed in a shape that conforms to an electromagnetic coil provided in the stator.

8. The cooling structure of the rotating electric machine according to claim 1, wherein
the first pipe is not in direct contact with a stator core, and
the second pipe is in direct contact with the stator core.

9. The cooling structure of the rotating electric machine according to claim 8, wherein
the first pipe is inserted into a slot formed in the stator core, and
the second pipe penetrates a back yoke of the stator core.
